(19) United States
(12) Patent Application Publication
(10) Pub. No.: US 2018/0123368 A1
(43) Pub. Date: May 3, 2018

(54) Wireless charging device and system thereof

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/854,764

(22) Filed: Dec. 27, 2017

(30) Foreign Application Priority Data
Dec. 29, 2016 (CN) 201611240295.5

(51) Int. Cl. H02J 7/00; H02J 7/04; H02J 7/02

(52) U.S. Cl. CPC H02J 7/0047; H02J 7/045; H02J 2007/0039; H02J 7/0029; H02J 2007/0049; H02J 7/025

(57) ABSTRACT

A wireless charging device includes: a battery management module, a transmission module, a charging module and a display module, which are electrically connected in sequence; wherein: the battery management module samples a charging voltage of a lithium battery in real time; the transmission module transmits the charging voltage to the charging module; the charging module adjusts a charging current according to the charging voltage received; and the display module displays the charging voltage and the charging current. As a result, the charging module communicates with the lithium battery being charged in real time, so as to obtain charging conditions of the lithium battery in time, which reduces charging abnormalities.

### CROSS REFERENCE OF RELATED APPLICATION

The present invention claims priority under 35 U.S.C. 119(a-d) to CN 201611240295.5, filed Dec. 29, 2016.

### BACKGROUND OF THE PRESENT INVENTION

### Field of Invention

The present invention relates to household appliances, and more particularly to a wireless charging device and a system thereof.

### Description of Related Arts

With the development of science and technology, more and more electronic devices use lithium batteries as the power source. For example, the majority of current mobile phones use lithium batteries because lithium batteries have high storage energy density, long service life up to 10,000 cycles, high power capacity, low self-discharge rate, and high and low temperature adaptability. Moreover, it is green and does not produce any toxic substances such as lead, mercury and cadmium during production, use and scrapping. Therefore, lithium batteries are widely used in recent years.

During the use of lithium batteries, they need to be regularly charged to ensure that lithium batteries have sufficient power supply. For charging, firstly, the charging module needs to be connected to a device equipped with a lithium battery via a charging cable, and then the charging module is connected to the power supply, that is, the plug of the charging module is plugged into the charging socket; when the charging module has been fully charged or needs to be temporarily used, the only action needed is to unplug the charging module. However, in the above charging process, the charging modules are only connected through the charging cable, and abnormalities (such as over-voltage or over-current) during the charging process of the charging modules cannot be informed in time.

### SUMMARY OF THE PRESENT INVENTION

Therefore, an object of the present invention is to provide a wireless charging device and a system thereof, wherein a charging module is able to obtain a charging state of a lithium battery being charged through setting a battery management module, a display module, etc.

A first aspect of the present invention provides a wireless charging device, comprising:

a battery management module, a transmission module, a charging module and a display module, which are electrically connected in sequence; wherein:

the battery management module samples a charging voltage of a lithium battery in real time;

the transmission module transmits the charging voltage to the charging module;

the charging module adjusts a charging current according to the charging voltage received; and

the display module displays the charging voltage and the charging current.

Preferably, the transmission module comprises a wireless transmitting unit;

wherein the wireless transmitting unit is connected between the battery management module and the charging module, and wirelessly transmits the charging voltage to the charging module.

Preferably, the transmission module further comprises a wireless receiving unit;

wherein the wireless receiving unit is connected to the wireless transmitting unit, and receives the charging voltage.

Preferably, the charging module comprises a voltage detecting unit and a voltage warning unit connected to each other; wherein:

the voltage detecting unit determines whether the charging voltage is higher than a preset voltage threshold; and

the voltage warning unit sends a voltage warning signal to the display module when the charging voltage is higher than the present voltage threshold.

Preferably, the charging module comprises a current detecting unit and a current warning unit connected to each other; wherein:

the current detecting unit determines whether the charging current is higher than a preset current threshold; and

the current warning unit sends a current warning signal to the display module when the charging current is higher than the present current threshold.

Preferably, the battery management module comprises a battery connecting unit and a battering monitoring unit, which are electrically connected in sequence; wherein:

the battery connecting unit stores at least one lithium battery to be charged; and

the battery monitoring unit samples the charging voltage of the lithium battery.

Preferably, the wireless charging device further comprises a storage module and an output module connected to each other; wherein:

the storage module records the charging voltage and the charging current in real time; and

the output module prints and outputs records of the charging voltage and the charging current.

Preferably, the charging module further comprises a current control button and a switch button; wherein:

the current control button adjusts the charging current;

the charging module communicates with the battery management module through the switch button when the lithium battery connected to the battery management module is detected; and

the charging module is cut off from the battery management module by the switch button when the charging voltage is higher than the preset voltage threshold.

Preferably, the display module is placed at a front face of the charging module.

A second aspect of the present invention provides a wireless charging system, comprising: a wireless charging device as mentioned above and electrical equipment;

wherein the wireless charging device is connected to the electrical equipment for supplying power to the electrical equipment.

According to the wireless charging device and the system of the present invention, the wireless charging device comprises: the battery management module, the transmission module, the charging module and the display module, which are electrically connected in sequence; wherein firstly, the battery management module samples a charging voltage of a lithium battery in real time; then the transmission module transmits the charging voltage to the charging module; the charging module adjusts a charging current according to the charging voltage received; and finally the display module displays the charging voltage and the charging current. With the battery management module, the transmission module, the charging module and the display module mentioned above, the charging module is able to obtain the charging state, i.e. the charging voltage, of the lithium battery being charged in real time, and adjust the charging current of the lithium battery according to the charging voltage, so as to effectively monitoring detailed conditions of the lithium battery being charged, which further avoids charging abnormalities.

These and other objectives, features, and advantages of the present invention will become apparent from the following detailed description, the accompanying drawings, and the appended claims.

### BRIEF DESCRIPTION OF THE DRAWINGS

To describe the technical solutions in the embodiments of the present invention or in the prior art more clearly, accompanying drawings required for describing the embodiments or the prior art are introduced below briefly. Obviously, the accompanying drawings in the following description only illustrate some embodiments of the present invention, and a person of ordinary skill in the art may still derive other drawings from these accompanying drawings without creative efforts.

FIG. 1 is a structural view of a wireless charging device according to a first embodiment of the present invention.

FIG. 2 is a structural view of a transmission module of the wireless charging device according to the first embodiment of the present invention.

FIG. 3 illustrates connection of a wireless charging system according to a second embodiment of the present invention.

FIG. 4 illustrates connection of a transmitting terminal of the wireless charging device according to the first embodiment of the present invention.

FIG. 5 illustrates connection of a receiving terminal of the wireless charging device according to the first embodiment of the present invention.

Element reference: 1—battery management module, 2—transmission module, 3—charging module, 4—display module, 21—wireless transmitting unit; 22—wireless receiving unit.

### DETAILED DESCRIPTION OF THE PREFERRED EMBODIMENT

The technical solutions in the embodiments of the present invention are clearly and completely described below with reference to the accompanying drawings according to the embodiments of the present invention. Apparently, the described embodiments are merely some but not all of the present invention. The components of the embodiments of the present invention, generally described and illustrated in the drawings herein, may be arranged and designed in a wide variety of different configurations. Accordingly, the following detailed description of the embodiments of the present invention provided in the accompanying drawings is not intended to limit the scope of the present invention, but merely to illustrate selected embodiments of the invention. All other embodiments obtained by persons skilled in the art based on the embodiments of the present invention without creative efforts shall fall within the protection scope of the present invention.

Conventionally, a lot of electrical equipment use lithium batteries as power source. During the use of lithium batteries, they need to be regularly charged to ensure that lithium batteries have sufficient power supply. For charging, firstly, the charging module needs to be connected to a device equipped with a lithium battery via a charging cable, and then the charging module is connected to the power supply, that is, the plug of the charging module is plugged into the charging socket; when the charging module has been fully charged or needs to be temporarily used, the only action needed is to unplug the charging module. However, in the above charging process, the charging modules are only connected through the charging cable. Therefore, the charging modules cannot obtain the charging conditions of the lithium batteries, and abnormalities during the charging process of the lithium batteries cannot be informed in time.

Accordingly, embodiments of the present invention provide a wireless charging device and a system thereof which are described below.

### Embodiment 1

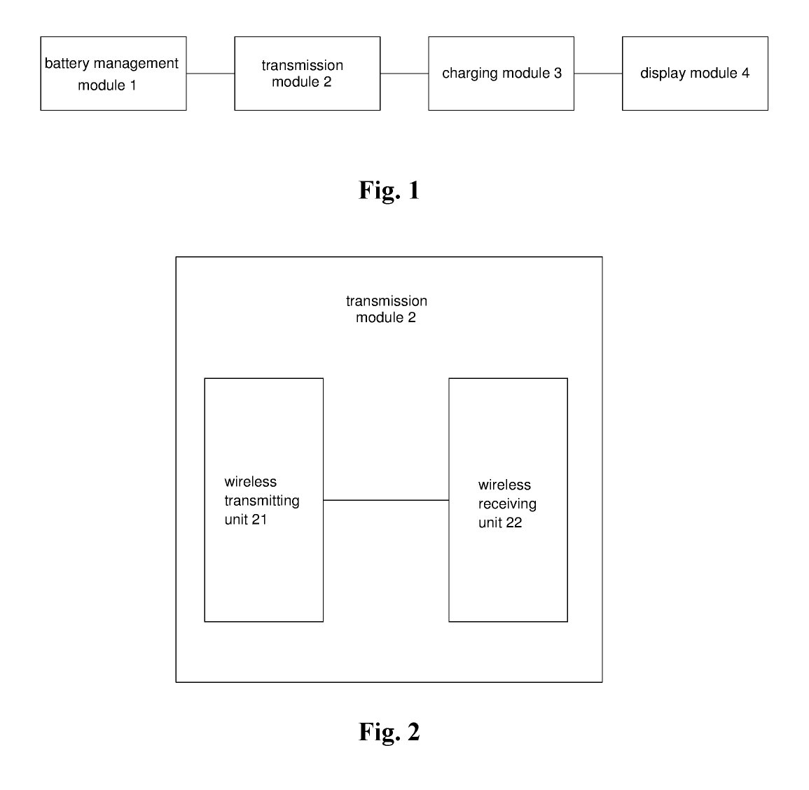

Referring to FIGS. 1 and 2 of the drawings, a wireless charging device according to a first embodiment of the present invention is illustrated, comprising: a battery management module 1, a transmission module 2, a charging module 3 and a display module 4, which are electrically connected in sequence. Detailed structures and utilizations are as follows.

First, the battery management module 1 is connected to a lithium battery being charged, so as to sample a charging voltage of the lithium battery in real time. In practice, battery amounts of different electrical equipment may be different. For example, a smart phone often contains one lithium battery, and a multi-functional flashlight usually contains multiple lithium batteries. Therefore, the battery management module 1 comprises: a battery connecting unit and a battering monitoring unit, which are electrically connected in sequence; wherein the battery connecting unit stores at least one lithium battery to be charged. When there is only one lithium battery to be charged, the lithium battery is directly placed in the battery connecting unit.

When there are multiple lithium batteries to be charged, correspondingly, there are multiple battery slots in the battery connecting unit. Moreover, the battery slots are connected in series or in parallel. During charging, the lithium batteries are placed in the battery slots in sequence for being correspondingly connected in series or in parallel, and charging terminals of the lithium batteries to be charged are all connected to a power source.

For charging the multiple lithium batteries as mentioned above, the batteries connecting unit is an adjustable battery slot. When the lithium batteries need to be charged, the charging module 3 of the lithium batteries is directly placed in the adjustable battery slot which is then adjusted according to a size of the charging module 3. A charging port (or a charging cable) of the charging module 3 is exported from the charging module 3, and is connected to the power source for charging the lithium batteries.

The battery monitoring unit samples the charging voltage of the lithium battery being charged. When there is only one lithium battery to be charged, the battery monitoring unit directly measures a voltage value of the lithium battery in real time, namely samples the charging voltage. When there are multiple lithium batteries to be charged, the battery monitoring unit respectively measures voltage values of the lithium batteries being charged in real time.

After sampling the charging voltage, the transmission module 2 transmits the charging voltage to the charging module 3, wherein the charging module 3 may be a charger, a mobile power source, a car charger, etc. Different from conventional wired charger, the transmission module 2 of the present invention comprises a wireless transmitting unit 21 and a wireless receiving unit 22, which omits a connecting cable between the lithium battery and the charging module 3, so as to solve problems that the charging cable is easy to be lost, and connection between the lithium battery and the charging module 3 is complex.

The wireless transmitting unit 21 is connected between the battery management module 1 and the charging module 3, and usually on the battery management module 1, so as to wirelessly transmit the charging voltage to the charging module. The wireless receiving unit 22 corresponds with the wireless transmitting unit 21 and is arranged on the charging module 3, so as to receive the charging voltage.

The charging module 3 adjusts a charging current according to the charging voltage received. For example, when there is only one lithium battery to be charged and the charging voltage is lower than a preset voltage threshold, the charging module 3 adjusts the charging current for rapidly charging. When the charging voltage of the lithium battery reaches the preset voltage threshold, the charging module 3 lowers or cuts off the charging current, so as to avoid battery damage due to an excessive charging voltage.

During the above process, the lithium battery is effectively protected. In addition, the charging module 3 further comprises a voltage detecting unit and a voltage warning unit connected to each other; wherein the voltage detecting unit determines whether the charging voltage is higher than the preset voltage threshold. Usually, the preset voltage threshold is set according to a battery capacity of the lithium battery to be charged, wherein the preset voltage threshold is no higher than the battery capacity. For a lithium battery with overvoltage protection, the preset voltage can be slight higher than the battery capacity. During charging, the voltage warning unit sends a voltage warning signal to the display module 4 when the charging voltage is higher than the present voltage threshold, so as to inform a user of charging abnormalities, and remind the user to stop charging.

Furthermore, the charging module 3 further comprises a current detecting unit and a current warning unit connected to each other; wherein the current detecting unit determines whether the charging current is higher than the preset current threshold. Usually, the preset current threshold is set according to maximum currents of the charging module 3 and of the lithium battery to be charged, wherein the maximum currents of the charging module 3 and of the lithium battery is no higher than the preset current threshold. During charging, the current warning unit sends a current warning signal to the display module 4 when the charging current is higher than the present current threshold, so as to inform the user of the charging abnormalities, and remind the user to stop charging.

According to the present invention, the charging module 3 further comprises a current control button and a switch button; wherein the current control button adjusts the charging current. The user is able to flexibly control the charging current of the charging module 3 through configuring the current control button, for satisfying different requirements. Besides, the charging module 3 communicates with the battery management module 1 through the switch button when the lithium battery connected to the battery management module 1 is detected, ensuring that the lithium battery is charged after being placed, so as to keep safety and normality of charging. The charging module 3 is cut off from the battery management module 1 by the switch button when the charging voltage is higher than the preset voltage threshold to stop charging, so as to provide double guarantees for safety.

The wireless charging device comprises the display module which displays the charging voltage and the charging current. Usually, the display module is placed at a front face of the charging module, which is conducive to observation of the charging conditions of the lithium battery and in time response to the charging abnormalities.

The wireless charging device further comprises a storage module and an output module connected to each other; wherein the storage module records the charging voltage and the charging current in real time; and the output module prints and outputs records of the charging voltage and the charging current. Usually, the output module is placed on the charging module 3 for outputting the charging voltage and the charging current by the charging module 3. As a result, the user can directly check printed data, which is convenient.

Referring to FIG. 4, three battery management modules 1 are connected in series, wherein each battery management module 1 charges twelve lithium batteries. The battery management module 1 adopts a battery management chip 1tc6802. The battery management module 1 communicates with the transmission module 2 through SPI, wherein the transmission module 2 adopts a master chip nRF24LE1 which can be replaced with wireless RF chips such as nrf51822 and CC2530. The transmission module 2 is mainly used for wirelessly transmitting, and communicates with the storage module through the SPI, wherein the storage module adopts a storage chip AT45DB62D for storing data of the lithium battery (such as temperatures). The storage chip is controlled by an RTC clock chip for storing. In addition, the transmission module 2 is also connected to a temperature control/self-test/reset system. For example, when the temperature of the lithium battery is higher than a preset standard value, then the temperature control system will play the role.

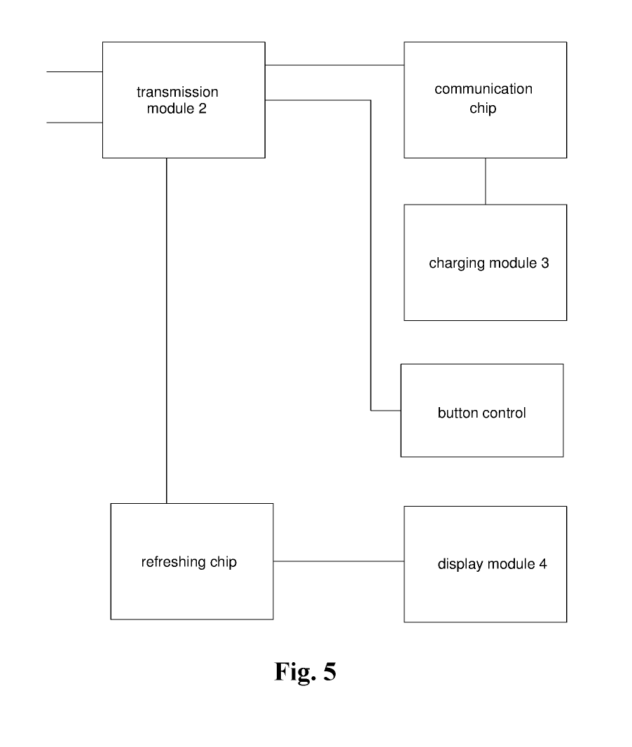

Referring to FIG. 5, the transmission module 2 adopts a master chip nRF24LE1 which can be replaced with wireless RF chips such as nrf51822 and CC2530. The transmission module 2 is mainly used for wirelessly receiving, and communicates with a communication chip through a CAN bus, wherein the communication chip adopts MCP2515 and TJA1040, and is similarly powered by the charging module 3. Preferably, the charging module 3 is a 3KW charger, and the transmission module 2 cooperates with button control through an I/O port. The transmission module 2 also communicates with a refreshing chip through a Uart port, wherein the refreshing chip is preferably Atmega168 for refreshing data to be displayed by the display module 4. Refreshed data is then sent to the display module 4 for being displayed.

In summary, the wireless charging device comprises: the battery management module 1, the transmission module 2, the charging module 3 and the display module 4, which are electrically connected in sequence; wherein the battery management module 1 samples the charging voltage of the lithium battery in real time; the transmission module 2 transmits the charging voltage to the charging module 3; the charging module 3 adjusts the charging current according to the charging voltage received; and the display module 4 displays the charging voltage and the charging current. In practice, the lithium battery to be charged wirelessly communicates with the charging module 3 (such as a charger), in such a manner that the charging module 3 obtains and adjusts the charging voltage and the charging current of the lithium battery in time, so as to be safer.

### Embodiment 2

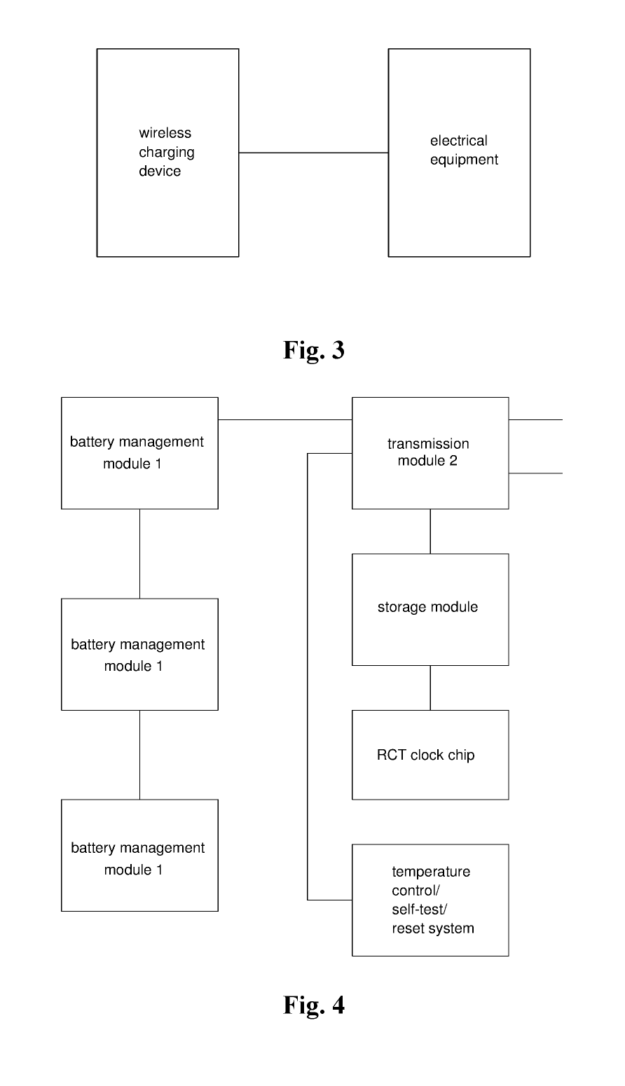

Referring to FIG. 3, a wireless charging system of the present invention comprises the wireless charging device as mentioned above and electrical equipment; wherein common electrical equipment comprises mobile phones, tablets, flashlights, etc. The wireless charging device is wirelessly connected to the electrical equipment for supplying power until the electrical equipment is fully charged.

Therefore, the wireless charging system according to a second embodiment comprises the wireless charging device as mentioned above and the electrical equipment; wherein the wireless charging device is connected to the electrical equipment for supplying power to the electrical equipment. As a result, the electrical equipment is easily connected to the wireless charging device, and is fully charged by the wireless charging device.

Finally, it should be noted that the above-mentioned embodiments are merely specific implementation manners of the present invention, for illustrating the technical solutions of the present invention, but not intended to be limiting. The protection scope of the present invention is not limited thereto. The embodiments of the present invention are described in detail. Those skilled in the art may still make modifications to the technical solutions described in the foregoing embodiments within the technical scope disclosed in the present invention. Besides, changes may be easily conceived or equivalent replacements may be made to part of the technical features. Any modification, change or replacement, which does not make the essence of the corresponding technical solutions depart from the spirit and scope of the technical solutions of the embodiments of the present invention, is within the scope of protection. Therefore, the protection scope of the present invention should be subject to the protection scope of the claims.

What is claimed is:

1. A wireless charging device, comprising: a battery management module, a transmission module, a charging module and a display module, which are electrically connected in sequence; wherein:
the battery management module samples a charging voltage of a lithium battery in real time;
the transmission module transmits the charging voltage to the charging module;
the charging module adjusts a charging current according to the charging voltage received; and
the display module displays the charging voltage and the charging current.

2. The wireless charging device, as recited in claim 1, wherein the transmission module comprises a wireless transmitting unit;
wherein the wireless transmitting unit is connected between the battery management module and the charging module, and wirelessly transmits the charging voltage to the charging module.

3. The wireless charging device, as recited in claim 2, wherein the transmission module further comprises a wireless receiving unit;
wherein the wireless receiving unit is connected to the wireless transmitting unit, and receives the charging voltage.

4. The wireless charging device, as recited in claim 1, wherein the charging module comprises a voltage detecting unit and a voltage warning unit connected to each other; wherein:
the voltage detecting unit determines whether the charging voltage is higher than a preset voltage threshold; and
the voltage warning unit sends a voltage warning signal to the display module when the charging voltage is higher than the present voltage threshold.

5. The wireless charging device, as recited in claim 1, wherein the charging module comprises a current detecting unit and a current warning unit connected to each other; wherein:
the current detecting unit determines whether the charging current is higher than a preset current threshold; and
the current warning unit sends a current warning signal to the display module when the charging current is higher than the present current threshold.

6. The wireless charging device, as recited in claim 1, wherein the battery management module comprises a battery connecting unit and a battering monitoring unit, which are electrically connected in sequence; wherein:
the battery connecting unit stores at least one lithium battery to be charged; and
the battery monitoring unit samples the charging voltage of the lithium battery.

7. The wireless charging device, as recited in claim 3, further comprising a storage module and an output module connected to each other; wherein:
the storage module records the charging voltage and the charging current in real time; and
the output module prints and outputs records of the charging voltage and the charging current.

8. The wireless charging device, as recited in claim 5, wherein the charging module further comprises a current control button and a switch button; wherein:
the current control button adjusts the charging current;
the charging module communicates with the battery management module through the switch button when the lithium battery connected to the battery management module is detected; and
the charging module is cut off from the battery management module by the switch button when the charging voltage is higher than the preset voltage threshold.

9. The wireless charging device, as recited in claim 1, wherein the display module is placed at a front face of the charging module.

10. A wireless charging system, comprising: a wireless charging device and electrical equipment;
wherein the wireless charging device comprises a battery management module, a transmission module, a charging module and a display module, which are electrically connected in sequence; wherein:
the battery management module samples a charging voltage of a lithium battery in real time;
the transmission module transmits the charging voltage to the charging module;
the charging module adjusts a charging current according to the charging voltage received; and
the display module displays the charging voltage and the charging current;
wherein the wireless charging device is connected to the electrical equipment for supplying power to the electrical equipment.
